(19) United States
(12) Patent Application Publication
(10) Pub. No.: US 2022/0184517 A1
(43) Pub. Date: Jun. 16, 2022

(54) WRITING INSTRUMENT FIDGET ASSEMBLY

(71) Applicant: Cody LESTER, Show Low, AZ (US)

(72) Inventor: Cody LESTER, Show Low, AZ (US)

(21) Appl. No.: 17/552,064

(22) Filed: Dec. 15, 2021

Related U.S. Application Data
(60) Provisional application No. 63/125,729, filed on Dec. 15, 2020.

(51) Int. Cl. A63H 33/26; B43K 29/00

(52) U.S. Cl. CPC A63H 33/26; B43K 29/00

(57) ABSTRACT

A writing instrument fidget assembly is disclosed. The assembly includes a finger mountable base and an attachment device to attach the assembly to a writing instrument, such as a pen or pencil. The base includes a bearing coupled within the base and a huh coupled to the bearing. When the attachment device is coupled to the base, the user can spin the writing instrument.

### BACKGROUND OF THE INVENTION

### Technical Field

This invention relates generally to a fidget device and more particularly to a fidget assembly for a writing instrument.

### State of the Art

The average person, particularly students, use writing instruments on a daily basis. Additionally, it is common for some people to feel the need to fidget particularly when needing to sit still for prolonged periods of time. The need to fidget is magnified for individuals who deal with conditions such as attention deficit disorder or attention deficit hyperactivity disorder. Conventional devices include fidget spinners, fidget cubes or like devices that allow a user to fidget with the device. These conventional devices are a separate devices that must be carried and held by a user in order to engage with the fidget aspect of the devices. These devices are not combinable with writing instruments.

Accordingly, what is needed is a fidget assembly for easy use with various types of writing instruments.

### SUMMARY OF THE INVENTION

The disclosed invention relates to a writing instrument fidget assembly and a method of using a writing instrument fidget assembly.

Disclosed is a writing instrument fidget assembly comprising a base configured to be mounted on a finger of a user, wherein the base includes a securing element and a bearing coupled to the base; a hub coupled to the bearing and a first magnet: and an attachment device configured to attach to a writing instrument, wherein the attachment device comprises a body member with a curved surface configured to receive the writing instrument and an opposing side to the curved surface comprising a second magnet. The attachment device may comprise an elastomeric element to couple and secure the writing instrument to the attachment device. The hub may be rotatable with respect to the base. The first magnet may be configured to releasably couple to the second magnet.

Disclosed is a method of using a writing instrument fidget assembly comprising: coupling a base of the writing instrument fidget assembly to a finger of a user, wherein the base includes a strap and a bearing coupled within the base, wherein a hub is coupled to the bearing and a first magnet; coupling an attachment device of the writing instrument fidget assembly to a writing instrument, wherein the attachment device comprises a body member with a curved surface configured to receive the writing instrument and an opposing side to the curved surface comprising a second magnet; coupling the first magnet to the second magnet; and spinning the writing instrument. The writing instrument may be a pencil. The writing instrument may be a pen. The attachment device may be an elastomeric element to couple and secure the writing instrument to the attachment device. The hub may be rotatable with respect to the base. The first magnet may be releasably coupled to the second magnet.

The foregoing and other features and advantages of the invention will be apparent to those of ordinary skill in the art from the following more particular description of the invention and the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a perspective assembled view of the writing instrument fidget assembly according to the invention;

FIG. 2 shows an exploded perspective view of the writing instrument fidget assembly according to the invention;

FIGS. 3A-3D show a perspective view, a top view, a side view and an end view respectively of a base of a writing instrument fidget assembly according to the invention;

FIGS. 4A-4C show a perspective view, a top view, and a side view respectively of a hub of a writing instrument fidget assembly according to the invention;

FIGS. 5A-5D show a perspective view, a top view, a side view and an end view respectively of an attachment device of a writing instrument fidget assembly according to the invention;

FIG. 6 shows a perspective view of a securing element of a writing instrument fidget assembly according to the invention;

FIGS. 7A-7C show a perspective view, a top view, and a side view respectively of a bearing of a writing instrument fidget assembly according to the invention;

FIG. 8 shows a perspective view of a magnet of a writing instrument fidget assembly according to the invention; and

FIG. 9 shows a perspective view of the writing instrument fidget assembly coupled to a hand according to the invention.

### DETAILED DESCRIPTION OF EMBODIMENTS OF THE INVENTION

As discussed above, embodiments of the present invention relate to a writing instrument fidget assembly.

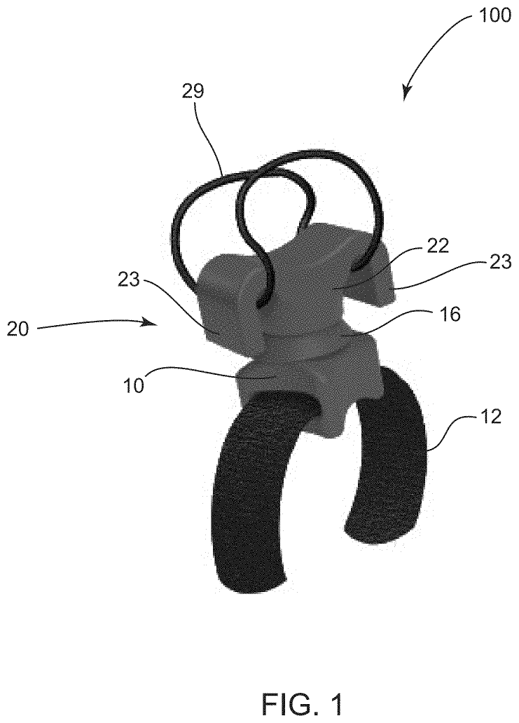

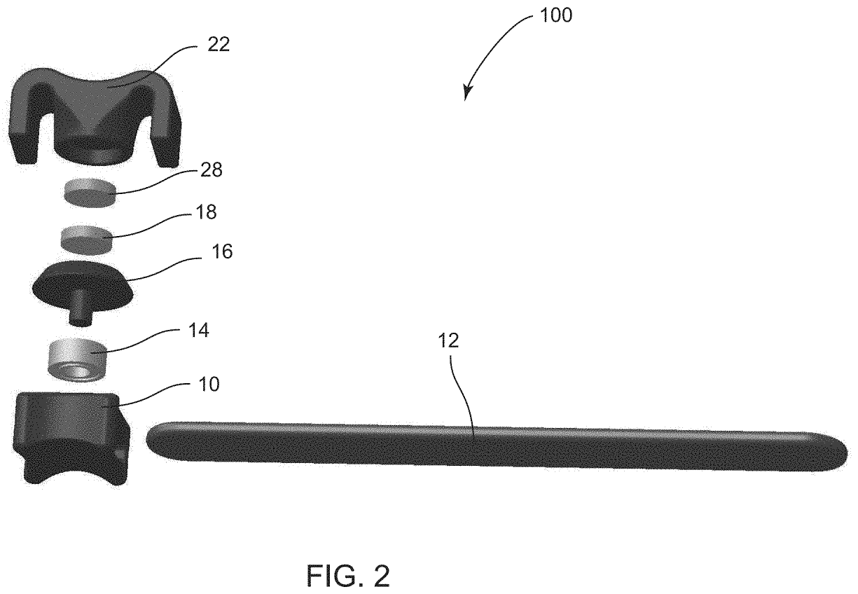

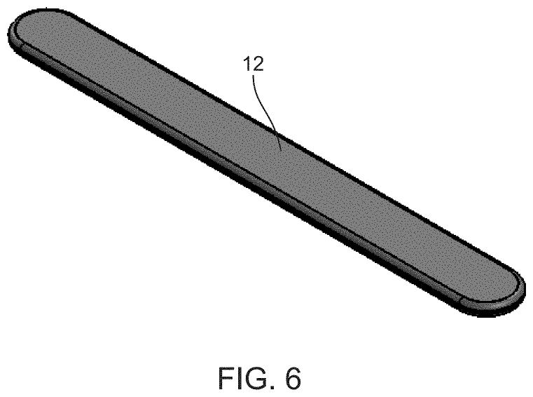

As shown in FIGS. 1-9, the fidget assembly 100 has two major components, a finger mountable base 10 and a writing instrument attachment device 20. The base 10 includes a securing element 12, such as a strap 12 or other securing element for coupling the base 10 to a finger of the user. The securing element 12, may be a loop, a clasp, a fixed ring formed in the base, an elastomeric ring and so forth. The base 10 further includes a bearing 14 coupled within the base 10 and a hub 16 coupled to the bearing 14, wherein the hub 16 can rotate with respect to the base 10. The hub 16 also includes a first magnet 18.

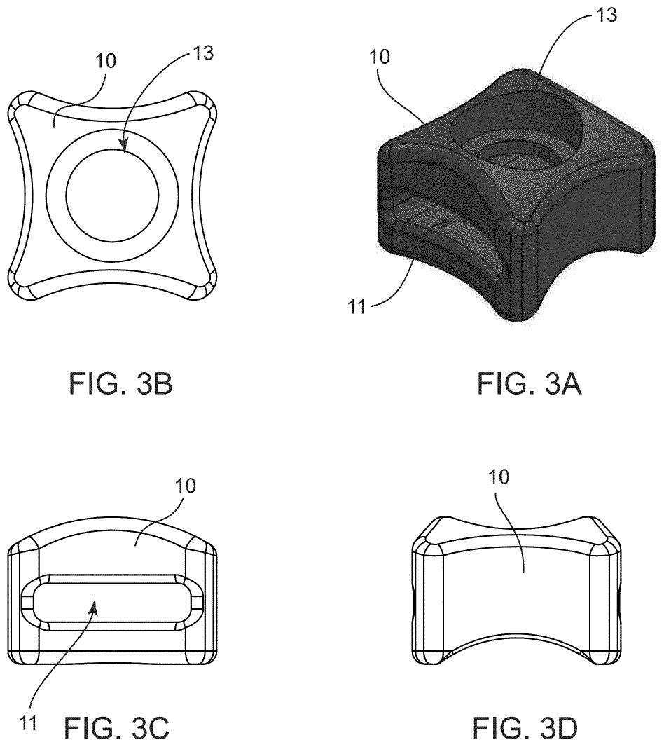

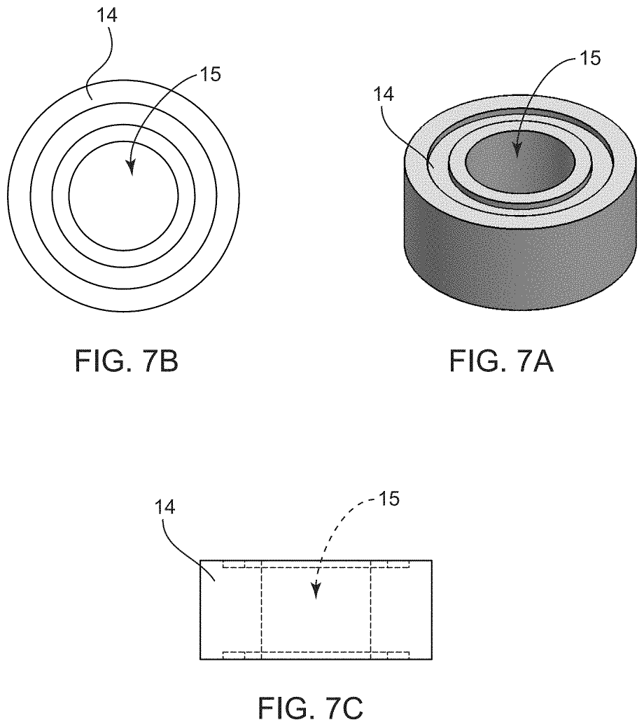

Referring to FIGS. 3A-3D, the base 10 may comprise an aperture 11 extending through a side of the base 10. The aperture is configured to receive the securing element 12 therethrough as shown in FIG. 1. Further, the base 10 may include a bearing recess 13 formed in a top surface of the base 10, wherein the bearing recess 13 is sized and shaped to receive and retain the bearing 14, as shown in FIGS. 7A-7C, within the bearing recess 13. The bearing 14 may be retained within the bearing recess 13 of the base 10 through a friction fit. A bottom surface of the base 10 may be a curved surface to correspond to the curvature of a finger that the base 10 is to be coupled to using the securing element 12.

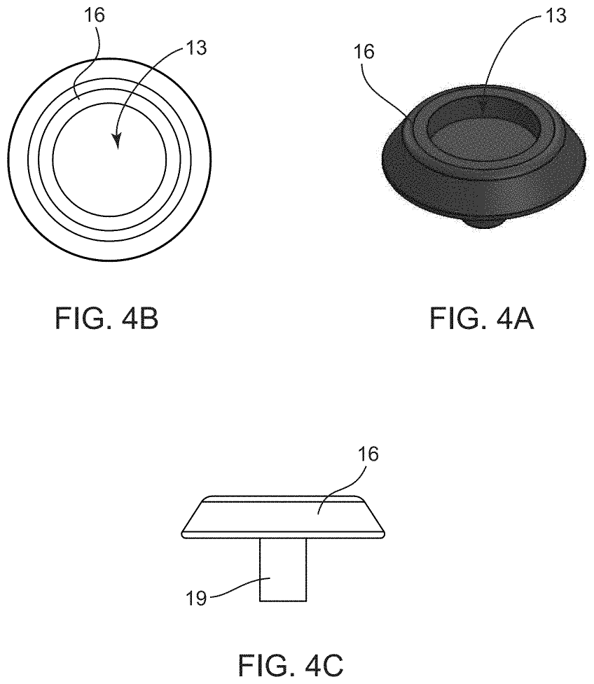

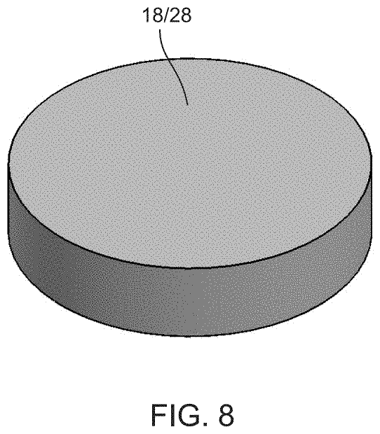

Referring additionally to FIG. 4A-4C, the hub 16 may include a main body portion that is frustoconical in shape. In a top surface of the hub 16, a magnet recess 17 may formed to receive and retain the first magnet 18 (see FIG. 8). The hub 16 may also include a protrusion 19, such as a cylindrical protrusion, extending from a bottom surface of the main body portion of the hub 16. The protrusion 19 may be configured to couple within a bearing aperture 15 extending through the bearing 14, as shown in FIGS. 7A-7C. This coupling may be a friction fit between the protrusion 19 and the inner surface of the bearing aperture 15 of the bearing 14. This allows the hub 16 to rotate by use of the bearing 14.

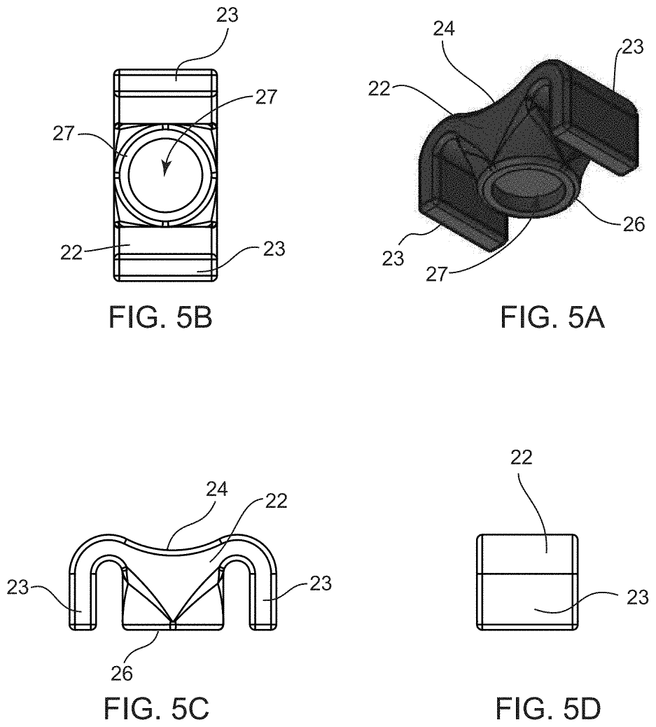

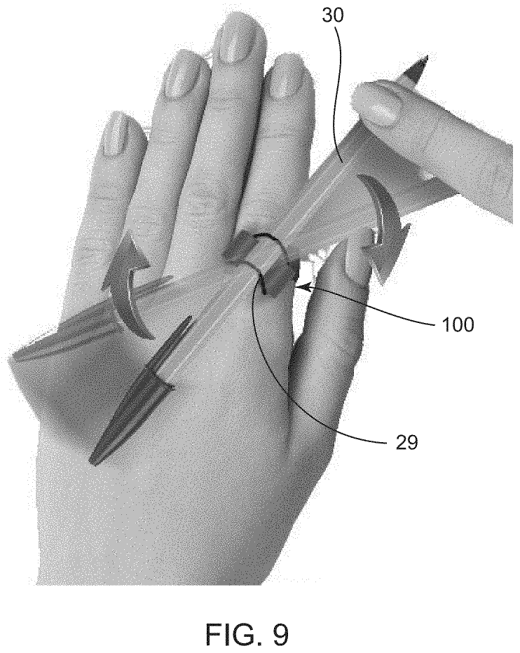

Referring to FIGS. 5A-5D, the writing instrument attachment device 20 includes a body member 22, which may include a curved top surface 24 that can receive a writing instrument 30 (see FIG. 9) and an opposing side 26 to the curved top surface 24, wherein the opposing side 26 includes a second magnet recess 27 for receiving and retaining a second magnet 28 (see FIG. 8), wherein the second magnet 28 may be coupled within the second magnet recess 27 through a friction fit. The second magnet 28 may be of opposing polarity to first magnet 18. While body member 22 is depicted with a curved surface 24, it is contemplated, that there may be embodiments where the curved surface 24 is not included, but a flat surface or some other type of surface that is not merely a curved surface.

The attachment device 20 may further include hook members 23 formed on opposing sides of the body member 22. The attachment device 20 in these embodiments may utilize an elastomeric element 29 to couple the writing instrument 30 to the attachment device 20 by use of the hook members 23 as shown in FIGS. 1 and 9. The elastomeric element 29 may be replaced with other types of writing instrument securing devices, for example, the elastomeric element 29 may be any type of securing element, such as, but not limited to, a hook and loop strap, a clip, a clasp or the curved surface 24 may be of a size and shape to provide for a friction fit with the writing instrument 30.

The second magnet 28 coupled to the attachment device 20 can be releasably coupled to the first magnet 18 of the hub 16. When the attachment device 20 is coupled to the base 10, the user can spin the writing instrument 30, as the hub 16 is rotatably supported by the bearing 14 within the base 10. The hub 16 is allowed to spin in each direction with respect to the base 10 and the base 10 is held in a fixed position in response to coupling the base to a finger of the user, as shown in FIG. 9.

Another embodiment includes a method of using a fidget assembly 100. The method may include coupling a base of the writing instrument fidget assembly to a finger of a user, wherein the base includes a strap, and a bearing coupled within the base, wherein a hub is coupled to the bearing and a first magnet; coupling an attachment device of the writing instrument fidget assembly to a writing instrument, wherein the attachment device comprises a body member with a recessed portion configured to receive the writing instrument and an opposing side to the recessed portion comprising a second magnet; coupling the first magnet to the second magnet; and spinning the writing instrument. The writing instrument may be a pencil. The writing instrument may be a pen. The attachment device may be an elastomeric element to couple and secure the writing instrument to the attachment device. The hub may be rotatable with respect to the base. The first magnet may be releasably coupled to the second magnet.

The components defining any writing instrument fidget assembly may be formed of any of many different types of materials or combinations thereof that can readily be formed into shaped objects provided that the components selected are consistent with the intended operation of a writing instrument fidget assembly. For example, the components may be formed of: rubbers (synthetic and/or natural) and/or other like materials; glasses (such as fiberglass) carbon-fiber, aramid-fiber, any combination thereof, and/or other like materials; polymers such as thermoplastics (such as ABS, Fluoropolymers, Polyacetal, Polyamide; Polycarbonate, Polyethylene, Polysulfone, and/or the like), thermosets (such as Epoxy, Phenolic Resin, Polyimide, Polyurethane, Silicone, and/or the like), any combination thereof, and/or other like materials; composites and/or other like materials; metals, such as zinc, magnesium, titanium, copper, iron, steel, carbon steel, alloy steel, tool steel, stainless steel, aluminum, any combination thereof, and/or other like materials; alloys, such as aluminum alloy, titanium alloy, magnesium alloy, copper alloy, any combination thereof, and/or other like materials; any other suitable material; and/or any combination thereof.

Furthermore, the components defining any writing instrument fidget assembly may be purchased pre-manufactured or manufactured separately and then assembled together. However, any or all of the components may be manufactured simultaneously and integrally joined with one another. Manufacture of these components separately or simultaneously may involve extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled with one another in any manner, such as with adhesive, a weld, a fastener (e.g. a bolt, a nut, a screw, a nail, a rivet, a pin, and/or the like), wiring, any combination thereof, and/or the like for example, depending on, among other considerations, the particular material forming the components. Other possible steps might include sand blasting, polishing, powder coating, zinc plating, anodizing, hard anodizing, and/or painting the components for example.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above.

1. A writing instrument fidget assembly comprising:
a base configured to be mounted on a finger of a user, wherein the base includes a securing element and a bearing coupled to the base;
a hub coupled to the bearing and a first magnet: and
an attachment device configured to attach to a writing instrument, wherein the attachment device comprises a body member with a curved surface configured to receive the writing instrument and an opposing side to the curved surface comprising a second magnet.

2. The writing instrument fidget assembly of claim 1, wherein the attachment device comprises an elastomeric element to couple and secure the writing instrument to the attachment device.

3. The writing instrument fidget assembly of claim 1, wherein the huh is rotatable with respect to the base.

4. The writing instrument fidget assembly of claim 1, wherein the first magnet is configured to releasably couple to the second magnet.

5. A method of using a writing instrument fidget assembly comprising:
coupling a base of the writing instrument fidget assembly to a finger of a user, wherein the base includes a strap and a bearing coupled within the base, wherein a hub is coupled to the bearing and a first magnet;
coupling an attachment device of the writing instrument fidget assembly to a writing instrument, wherein the attachment device comprises a body member with a curved surface configured to receive the writing instrument and an opposing side to the curved surface comprising a second magnet;
coupling the first magnet to the second magnet; and
spinning the writing instrument.

6. The method of claim 5, wherein the writing instrument is a pencil.

7. The method of claim 5, wherein the writing instrument is a pen.

8. The method of claim 5, wherein the attachment device comprises an elastomeric element to couple and secure the writing instrument to the attachment device.

9. The method of claim 5, wherein the hub is rotatable with respect to the base.

10. The method claim 5, wherein the first magnet is releasably coupled to the second magnet.
